(19) United States
(12) Patent Application Publication
(10) Pub. No.: US 2024/0109361 A1
(43) Pub. Date: Apr. 4, 2024

(54) PHOTO BOOK WITH MEDIA PLAYBACK

(71) Applicant: MEMPERIENCE GMBH, Karlsruhe (DE)

(72) Inventor: Cedric MANDEL, Ettlingen (DE)

(73) Assignee: MEMPERIENCE GMBH, Karlsruhe (DE)

(21) Appl. No.: 18/554,011

(22) PCT Filed: Apr. 7, 2022
(86) PCT No.: PCT/EP2022/059234

§ 371 Date: Oct. 5, 2023

(30) Foreign Application Priority Data
Apr. 8, 2021 (DE) 10 2021 108 726.0

(51) Int. Cl. B42D 1/00; B42D 3/12

(52) U.S. Cl. CPC B42D 1/007; B42D 3/123; B42D 3/126; H02J 50/10

(57) ABSTRACT

The present invention relates to a photo book (10), with: a display (12) for displaying a predefinable media content, wherein the display is arranged in a display page (14) of the photo book; a control electronics (16) for controlling the display, wherein the control electronics is arranged in a module compartment (18) of the photo book; and a connection (20) for electrically connecting the display to the control electronics, wherein, in a closed state of the photo book, the connection runs through a cutout (22) in a book spine (24) of the photo book. The present invention furthermore relates to a receiving device (65) for mounting a photo book (10).

The present invention relates to a photo book as well as a receiving device for mounting a photo book.

Photo books are books with photos and/or text contents on the pages. A user can design the contents himself on a regular basis and can have a copy made, which is digitally printed for the most part. On the one hand, photo books are thereby used to store and to allow access to memories in the private sphere and, on the other, also for advertising purposes, during product presentations, in application processes, etc. in the commercial environment. The differentiation from conventional photo albums, in which printed photographs made of paper are stored, is blurred thereby because photo books can also comprise printed photographs at one or several points or other contents made of paper and because there are hybrid forms in this respect.

In particular due to the increasing presence of mobile devices, such as smartphones, and the rising quality of the cameras integrated therein, videos, animations with movement components and other media contents are recently also being created more and more frequently in addition to classic photos.

Classic photo books and photo albums can allow access to media contents of this type only to a limited extent. There is a need for allowing access to media contents in this respect.

In this context, a photo book with OLED displays for starting videos is disclosed in DE 20 2014 000 347 U1. It is in particular proposed to embed or glue a display into the page at a point within a book. Several displays can also be used thereby.

A book, in particular a photo book, with a book cover and an inner book, which has book pages and which is arranged within the book cover, is described in DE 2013 109 104 A1. The book furthermore comprises a flat electronic display with a display, which is integrated into one of the book pages.

A device and a method for connecting a media playback device to a printed product is disclosed in US 2015/0355820 A1. An album has a cover with a media playback device connected thereto.

A folder for a menu and/or beverage menu with a flat lighting module as well as a holding device for the folder, and a production method for the lighting module is described in DE 10 2020 102 656 A1.

EP 3 675 317 A1 relates to an inductive charging device with a rotatable magnetic mount.

It is a disadvantage of current approaches that the integration of the display and of the necessary electronic components can lead to a heavy page, which is difficult to handle for the viewer when turning the page. This can also be seen in that until now, the display was for the most part integrated into the last page or into the back cover, respectively. Existing approaches furthermore have the disadvantage that turning the page leads to a high mechanical stress on displays and cables, which results in a high error rate or a decreased service life. Lastly, the production of existing approaches is often complex, so that resulting prices are too high to allow for a wide application.

Based on this, the present invention has the object of providing a photo book, which can be manufactured efficiently, with an option for playing back a media content, and with a higher service life. In particular, a mechanically resilient photo book with low error rate with multiple use is to be provided.

To solve this object, the present invention, in a first aspect, relates to a photo book, with:
a display for displaying a predefinable media content, wherein the display is arranged in a display page of the photo book;
a control electronics for controlling the display, wherein the control electronics is arranged in a module compartment of the photo book; and
a connection for electrically connecting the display to the control electronics, wherein, in a closed state of the photo book, the connection runs through a cutout in a book spine of the photo book.

In a further aspect, the present invention relates to a receiving device for mounting a photo book with a photo book as described above, with:
a charging device for inductively charging an energy storage of the photo book; and/or
a locking mount for locking the photo book in a locked position in the receiving device, wherein the locking mount preferably comprises a magnet.

Preferred embodiments of the invention are described in the dependent claims. It goes without saying that the features mentioned above and the features, which will be described below, cannot only be used in the respective specified combination, but also in other combinations or alone, without leaving the scope of the present invention. In particular, the receiving device can be configured according to the embodiments described for the photo book in the dependent claims.

According to the invention, it is provided that at least one display for displaying a predefinable media content is integrated into a photo book. The media content can thereby in particular be a video, but also an animation or a still or changeable image or photo, respectively. The display is controlled by means of a control electronics. This control electronics is arranged in a module compartment of the photo book. Display and module compartment are arranged at separate positions within the photo book in this respect. The connection between display and module compartment or control electronics, respectively, runs through a cutout in a book spine of the photo book, when the photo book is closed. When the photo book is open, the connection does not necessarily have to run through the cutout in the book spine. A cutout is understood herein in particular as a cavity or recess, respectively. A cutout can be open on one side or on several sides and can also be formed in the shape of a section in this respect. In particular, a cutout is a region of the book spine or of a page, respectively, or a layer of a page, in which material was removed or stripped, respectively. It goes without saying that it can also be possible that the cutout is produced by applying or attaching additional material next to a free region. It is likewise conceivable that the cutout corresponds to a free region between book spine and inner book, which is dimensioned accordingly for receiving the connection. In other words, the distance between book spine and inner book can thus be enlarged, in order to form the cutout. The connection comprises in particular a metal wire and/or a conductor track, which is at least partially guided through the cutout. According to the invention, it is thus provided that a signal line for conducting an electrical signal is guided through a cutout in the book spine.

Compared to current approaches, in the case of which data lines are already integrated into paper or are glued between two pages, the stress of the data lines when bending and/or folding the pages is decreased by means of the cutout provided according to the invention. The connection can be guided through the book spine, without being bent sharply when leafing through. A bending radius of the connection during the bending is enlarged by means of the cutout. On the one hand, this brings about an extended service life of the photo book and, on the other hand, provides for the use of standard materials for the connection, whereby costs can be saved. In addition, advantages result in the manufacturing because a connection running through the cutout can be produced efficiently and does not require any special materials or adapted bending points, respectively. It is in particular made possible to adapt a standard photo book, in order to additionally provide for a media playback.

In a preferred embodiment, the connection between the cutout in the book spine and the display runs in a cutout in the display page. In a sectional view orthogonal to the book spine, the cutout in the display page preferably has an at least partially wedge-shaped profile with a larger height on a page facing the book spine. The cutout for the connection has the effect that the stress on the connection when leafing through the photo book is kept low. A bending radius is enlarged or a sharp kinking of the connection is prevented, respectively. The service life of the photo book is extended. Due to the wedge-shaped profile or due to a varying height of the cutout in the display page, respectively, a large bending radius of the connection can be ensured on the one hand, and a stability of the photo book can be improved by avoiding an empty space on the other hand.

In a preferred embodiment, the display is arranged in a cutout in the display page. Additionally or alternatively, the module compartment is arranged in a cutout in a module page of the photo book. As above, a cutout can thereby in particular refer to a section or a cavity, which can be arranged on the edge as well as in an inner region of a page of the photo book. A module page can also be any page of the photo book, which has a section or a cavity, within which the module compartment is then arranged, in turn.

In a preferred embodiment, the module compartment is arranged in a cutout in a book cover of the photo book. Preferably, the cutout is arranged in a back book cover of the photo book. Compared to the further pages of the photo book, a thicker book cover is provided for the most part. The module compartment can be placed into this book cover, in order to limit the haptics and optics of the photo book as little as possible. Due to an arrangement within the back book cover of the photo book, the handling is further simplified for the viewer. It is not necessary for the most part to turn over the module compartment and the control electronics arranged therein, which may be comparatively heavy.

In a preferred embodiment, the module compartment is covered by a layer of a page of the photo book. A layer of a page of the photo book is understood to be a part of a multi-layer page setup. Due to the covering of the module compartment, the latter can be protected against environmental influences. Additionally, the module compartment is covered from the outside and becomes inaccessible, whereby the optics and haptics of the photo book are further improved. The module compartment can thereby in particular also be covered by several layers, preferably by all layers of a page of the photo book.

In one embodiment, the module compartment is arranged in at least one cutout of a module page of the photo book, which is connected to the book cover. Preferably, the module compartment is covered by a layer of the module page. The connection between book cover and module page can in particular be established by means of gluing. A layer of the module page is understood to be a part of a multi-layer page setup. The module page is a page of the photo book. A cutout, which is in particular provided only in at least one layer of the module page, is provided in this page. The cutout corresponds to a section in a layer in this respect. Due to the arrangement of the module compartment in the further module page, the module compartment can be enlarged. On the one hand, a larger or higher control electronics, respectively, can be provided. On the other hand, further components can be received within the module compartment. Due to the covering of the module compartment, the latter can be protected against environmental influences. In addition, the module compartment is covered from the outside and becomes inaccessible, whereby the optics and haptics are further improved.

In a preferred embodiment, the display page is constructed of at least three layers. The display is arranged in a cutout in a middle layer of the at least three layers and in a cutout in an upper layer of the at least three layers, which is assigned to a front side of the display. A lower layer of the at least three layers, which is assigned to a rear side of the display, does not have a cutout in the region of the display. The connection runs between book spine and display, preferably in a cutout in the middle layer. The display page is constructed in several layers and the display is arranged in a cutout, thus in a section or a cavity, in a middle layer. In particular, a section can be provided in the middle layer. This cutout is continued in the upper layer, so that the front side of the display is visible. In contrast, the rear side is covered by at least one layer, so that the rear side cannot be viewed when turning over the display page but is concealed by the lower layer. Lower and upper layer can thereby in particular be photo paper layers, so that photos can be printed thereon. Due to the further use of a cutout in the middle layer for receiving the connection, a mechanical stress on the connection can be further reduced and a production process can thus be simplified as well as a service life of the book can be extended.

In a preferred embodiment, the cutout in the upper layer is smaller than the cutout in the middle layer, so that the upper layer covers an edge of the display. Additionally or alternatively, the upper layer and the lower layer thereby comprise photo paper. For production reasons, current displays for the most part have at least one edge, which cannot be used to display a media content. A portion of the display cannot be used in this respect. This edge surrounds the display region. Due to the fact that the cutout in the middle layer is larger than the cutout in the upper layer, this edge is concealed. The viewer only sees the display region of the display. In other words, a type of undercut is provided. An improved optics results. In addition, a fastening of the display in the cutout can be attained. This embodiment with an edge of the display, which is covered by an upper layer of a page, can be provided independently of the cutout in the book spine and also independently of a separation of control electronics and display. In this respect, this embodiment can be used in an advantageous manner in all types of photo books with a display and can also be combined with the further embodiments disclosed herein.

In a preferred embodiment, the display page is constructed of two pages of the photo book, which are connected in a production process, preferably by means of gluing. The two pages of the photo book are preferably constructed of three layers each. In particular, the pages of the photo book can be constructed of a central base layer, for example of cardboard, and two photo paper layers, which are glued to this base layer in the front and in the back. Due to the fact that the display page comprises two pages, the cutout or the space for the display, respectively, can be enlarged. In particular, a comparatively thicker display can also be received. In addition, the production process can be simplified because the processing and the introduction of the cutouts can take place prior to the connecting. The effort can be reduced in this respect because possible damages and/or marks are no longer visible anyway for the viewer after the connecting.

In a preferred embodiment, the photo book comprises an opening sensor for detecting when the display page is opened. The opening sensor preferably comprises a magnetic field sensor for detecting a magnetic field change or a brightness sensor for detecting a brightness change and/or is integrated into the connection. The control of the display can be improved by means of an automatic detection of when an opening occurs. This detection can take place, for example, by means of a change of a magnetic field or of a brightness. Efficiency advantages in the production or cost advantages, respectively, result from an integration into the connection.

In a preferred embodiment, the display is configured for displaying the media content when the opening of the display page is detected by the opening sensor. Preferably, the display is configured for displaying the media content after a predefined delay time. A simple operating option of the photo book or of the display, respectively, is made possible. In addition, energy can be saved by an activation of the display only during a viewing. The use of a predefined delay time results in a further improved operability. In particular, corresponding operating elements can be omitted, whereby the operation can be simplified as well as production costs can be saved.

In a preferred embodiment, the connection comprises a flexible printed circuit board with at least one conductor track. The flexible printed circuit board preferably has an offset region with an offset in a direction parallel to the book spine, so that the connection point of the connection on the display is arranged at a different point along a longitudinal axis parallel to the book spine than a connection point of the connection on the control electronics. A flexible printed circuit board provides for a foldability and/or bendability with comparatively low costs. In addition, a flexible printed circuit board provides for an additional introduction of an offset. A larger flexibility during the positioning of the display with respect to the control electronics can be attained by means of the offset. In particular, the two components can be arranged in a direction parallel to the book spine at different points within the photo book. In other words, display, control electronics, and connections can be arranged at any points at the height of the respective pages. A cost-efficient producibility with high flexibility results.

In a preferred embodiment, a pinout of the control electronics and/or of the display has a symmetrical pin assignment for connecting the connection. In other words, the connection of the connection is established inversely. The mounting orientation of a connection of the connection to displays is often predefined by an asymmetrical pin assignment of the display. For example, a ribbon cable or a flexible printed circuit board can only functionally connect the control electronics to the display in this case, when the connection has the same orientation at both connections. When the pinout of the control electronics and of the display have a symmetrical pin assignment, a connection, which is formed to be capable of being connected on both sides, can be connected to the control electronics and the display in different orientations. It becomes possible thereby to connect displays in the photo book on even and odd pages with the same type of connection. In particular, a connection of displays on odd and even pages can take place by means of a uniformly formed flexible printed circuit board or of a uniformly formed ribbon cable because the connection direction at the control electronics can be double-sided due to the symmetrical pin assignment. A more efficient manufacturing results.

In a preferred embodiment, the connection has a meander-shaped profile in a folding region in a plane orthogonal to the book spine, so that the connection in this folding region is configured for compensating a change of a distance between the display and the control electronics when opening and closing the photo book and/or when leafing through the photo book by means of a change of a folding position. The folding region is preferably arranged in the module compartment of the photo book. The connection is folded in the folding region and has a meander-shaped profile or a loop-like profile, respectively, in this respect. In other words, the connection has a profile with two changes in direction in a plane perpendicular to the book spine or perpendicular to the pages of the photo book, respectively. Due to the meander-shaped profile, the connection can be pulled out of the folding region and can be inserted into it again. The length of the connection outside of the folding region is variable in this respect. Due to the variability of this length, a pull-out or return of the connection into the folding region, respectively, can be attained due to the variability of this length when leafing through. The mechanical stress on the connection is reduced thereby. In particular, tensile and shear forces can be avoided. In addition, a kinking can be prevented so that the service life of the connection is improved and a connection can be made of standard materials. In addition, a different distance to a plug or several plugs on a printed circuit board of the control electronics can also be compensated. In the case of a different distance, a standard cable length can thus be used. Further cost advantages during the production of the photo book result thereby.

In one embodiment, the photo book comprises a protective frame for receiving a portion of the connection. An inner region of this protective frame forms the folding region. In other words, the folding region or a portion of the connection, respectively, is thus received within a protective frame. The mechanical stress on the connection can be reduced in this portion thereby. A kinking and/or a high stress or error rate resulting therefrom can be avoided. The connection is particularly protected in the folding region, so that a long service life of the connections of the photo book is attained.

In a preferred embodiment, the photo book comprises at least one further display, which is arranged in the display page or in a further display page of the photo book. The control electronics is formed for controlling the at least one further display. In addition, the photo book comprises at least one further connection for electrically connecting the at least one further display to the control electronics. The at least one further connection preferably runs through the same cutout in the book spine of the photo book. Several displays can be provided, so that several identical or different media contents can be played back. Each display is thereby connected to the same (one) control electronics via a separate connection. A control electronics controls several displays in this respect. The different connections can in particular be guided through the same cutout in the book spine. An efficient production can be attained thereby. In addition, advantages result to the effect that only a single control has to be used.

In a preferred embodiment, the photo book comprises a loudspeaker for outputting an audio signal. The control electronics is configured for controlling the loudspeaker. Additionally or alternatively, the loudspeaker is configured for outputting the audio signal into a rebate region of the photo book. Further additionally or alternatively, the loudspeaker is arranged within the module compartment. Preferably, the loudspeaker adjoins the rebate region of the photo book or protrudes into it. In particular, noises corresponding to the media contents can also be played back. The loudspeaker can thereby preferably be arranged in the module compartment. The loudspeaker can advantageously be arranged so that the audio signal is output into a rebate region of the photo book. The rebate region is thereby the region between inner book and book cover. In the open state of the photo book, sound can escape to the outside from the module compartment through the rebate region. The loudspeaker is not visible from the outside. The use of a loudspeaker, which emits the sound directly into the rebate region, is particularly advantageous. Provided that the structural form of the loudspeaker permits an arrangement of the sound escape in a direction parallel to the book cover in the direction of the rebate region, it is advantageous when the sound escape takes place in the direction of the rebate region and/or the loudspeaker is installed so as to adjoin the rebate region. Due to the positioning of the loudspeaker in/near the rebate region, the sound can be improved. If the loudspeaker does not protrude into the rebate region, the rebate region can be dimensioned to be smaller and the optics can be further improved thereby. In addition, a mechanically resistant solution can be attained.

In a preferred embodiment, the photo book comprises an energy storage, which is configured for inductively receiving energy from a receiving device and/or which comprises a lithium ion storage. Due to an inductive reception of energy, an inductive charging can be attained. In addition to the actual storage, the energy storage also comprises the necessary charging electronics in this respect. An efficient charging option, which can be realized cost-efficiently and comfortably, is provided.

In a preferred embodiment, the photo book comprises a module frame for receiving the control electronics and the further components in the module compartment, wherein the module frame is configured for introduction into the module compartment. The components are positioned and protected by means of the module frame.

In a preferred embodiment, the photo book comprises a first switching unit for switching the control electronics and the display on and off and/or for controlling functions of the control electronics. The first switching unit is preferably arranged in the module compartment and is configured as a button arranged on an edge of a book cover of the photo book. Alternatively, the first switching unit can be arranged in the module compartment and can be configured as a button, which is concealed under a layer of a module page and/or as a touch sensor, which can be operated through the layer of the module page. Due to a separate option for switching on and off, a stand-alone operation of the photo book can be made possible. In particular, depending on the application, an energy saving and thus a longer period of use can be made possible therewith.

In a preferred embodiment, the photo book comprises a second switching unit for switching the control electronics and the display when the photo book is removed from a receiving device. The second switching unit preferably comprises a magnetic field sensor for detecting a magnetic field and/or an interruption sensor for detecting an interruption of a charging current. Due to the second switching unit, a comfortable operation or viewing of the photo book, respectively, can be made possible. An automated operation of the switch-on or switch-off in cooperation with a receiving device is made possible. The viewer removes the photo book from the receiving device and activates it directly without further input. A comfortable operation is made possible.

In a preferred embodiment, the photo book comprises a locking unit for locking the photo book in a locked position in a receiving device. The locking unit preferably comprises a magnet in the region of a rear side of the photo book. Due to a locking, a positioning can be predefined. This provides for a simple inductive charging as well as for a secure mounting. In particular, a magnet can be used, which cooperates with a corresponding metal piece or counter magnet, in order to attain the locking and centering.

A photo book can in particular comprise several pages as well as a cover with the book spine, which are joined in a production process in a so-called marriage. A photo book is in particular understood herein to be a digitally printed book with printed photos on one or several pages. The term photo book, however, can also be understood herein to be a different book, which in particular does not have to include photos. A book with text or other contents and with one or several displays can also represent a photo book in this respect. A connection can be any type of connection. In particular, a cable, a ribbon cable, or a flexible printed circuit board (flex printed circuit board) can be used. A cutout is in particular a depression or a section. A cutout can be introduced subsequently into an existing material, for example by means of milling or laser cutting.

The invention will be described and explained in more detail below on the basis of a few selected exemplary embodiments in connection with the enclosed drawings, in which:

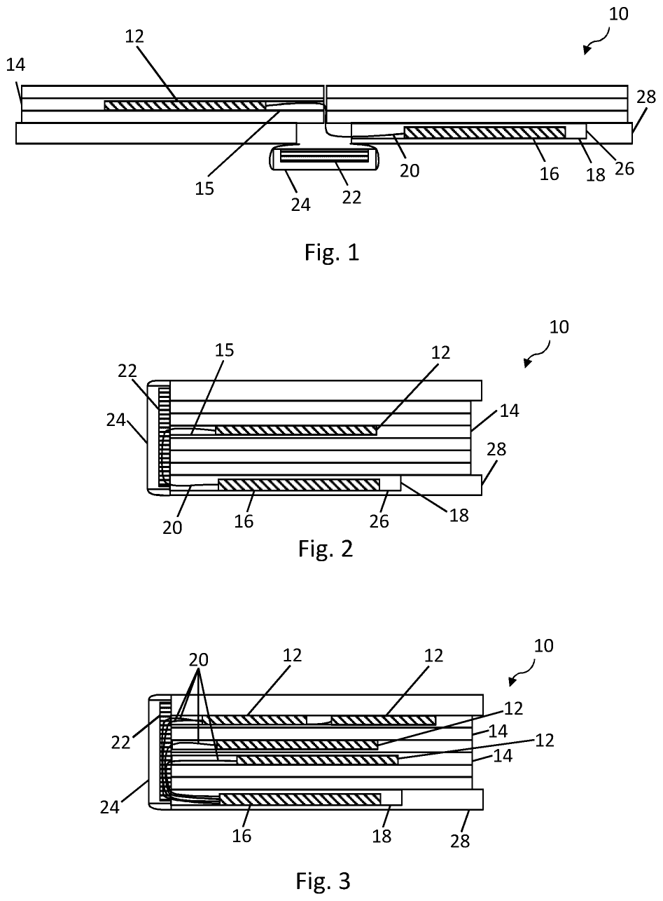

FIG. 1 shows a schematic illustration of a photo book according to the invention in the open state;

FIG. 2 shows a schematic illustration of the photo book in the closed state;

FIG. 3 shows a schematic illustration of a photo book with several displays;

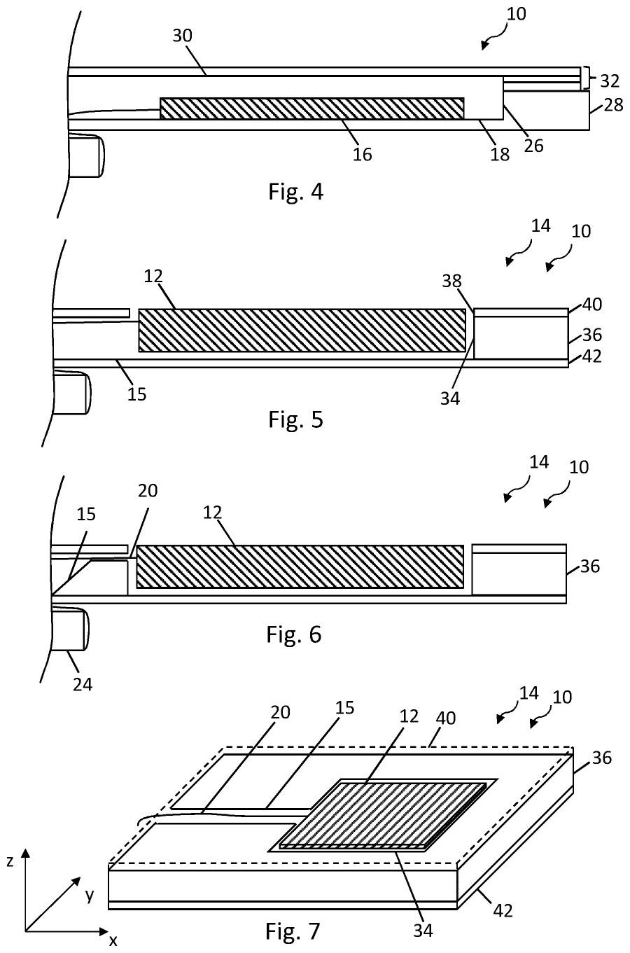

FIG. 4 shows a schematic illustration of a module compartment integrated into a back book cover;

FIG. 5 shows a schematic illustration of a display in the display page;

FIG. 6 shows a schematic illustration of a display page with advantageous cutout for the connection;

FIG. 7 shows a schematic perspective illustration of the display page;

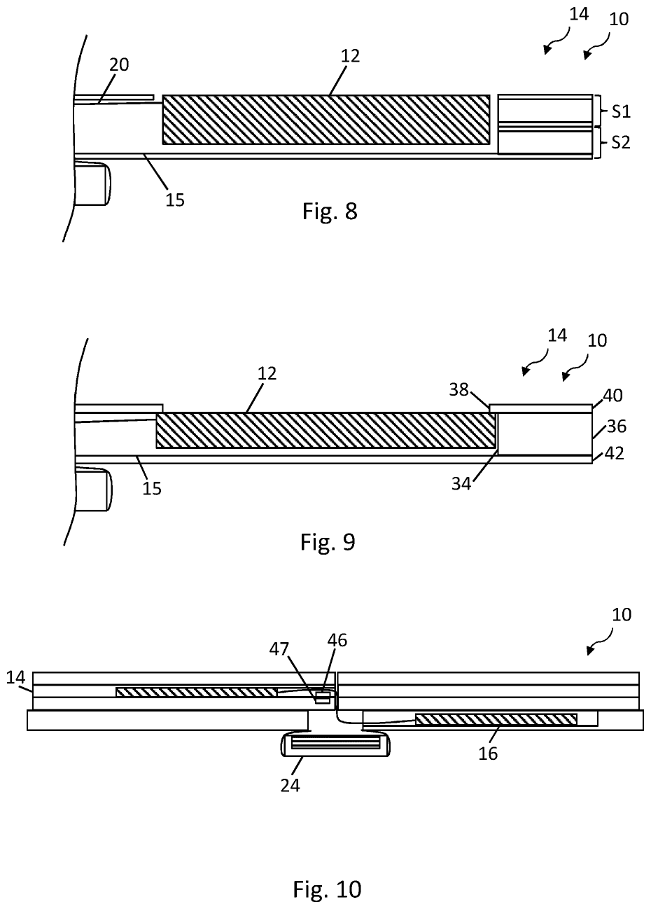

FIG. 8 shows a schematic illustration of a multi-layer display page;

FIG. 9 shows a schematic illustration of a display page with undercut;

FIG. 10 shows a schematic illustration of a photo book with opening sensor;

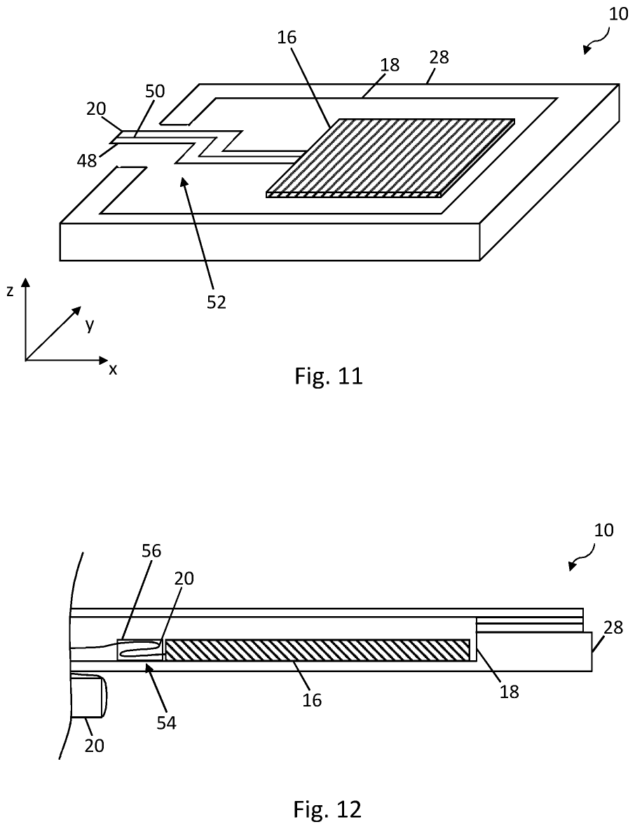

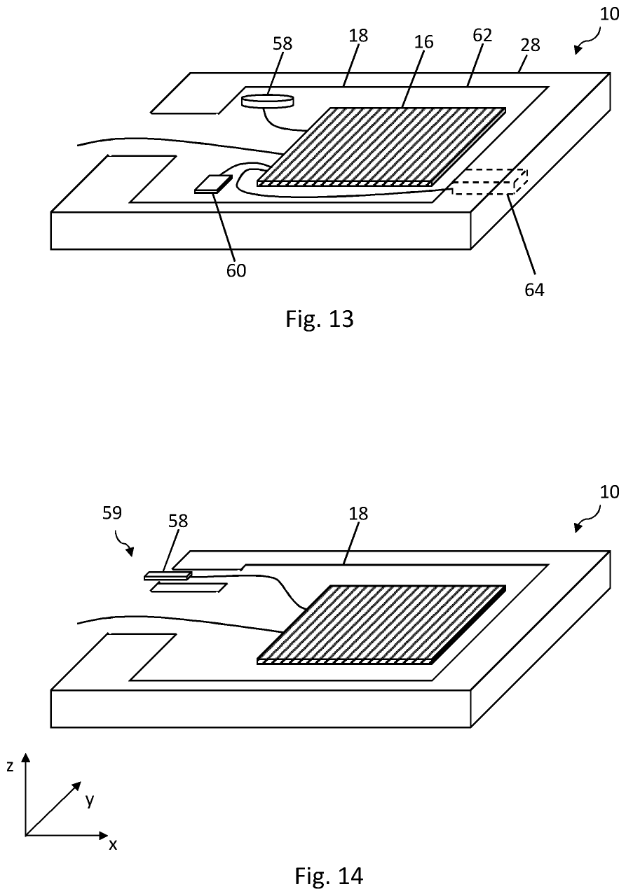

FIG. 11 shows a schematic perspective illustration of a flexible printed circuit board as connection;

FIG. 12 shows a schematic illustration of a meander-shaped profile of the connection in a folding region;

FIG. 13 shows a schematic perspective illustration of further optional components in the module compartment;

FIG. 14 shows a schematic perspective illustration of an advantageous arrangement of a loudspeaker in the module compartment;

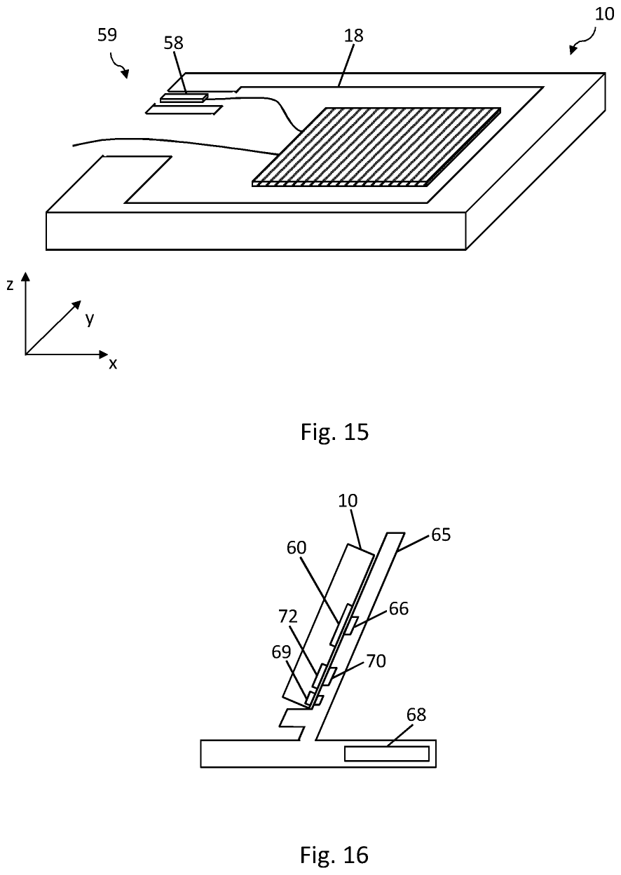

FIG. 15 shows a further schematic perspective illustration of an advantageous arrangement of a loudspeaker; and

FIG. 16 shows a schematic illustration of a photo book in a receiving device.

A photo book 10 according to invention is illustrated schematically in FIGS. 1 and 2 in the open (FIG. 1) and in the closed state (FIG. 2). The illustration are to be understood thereby as (not true to scale) sectional views in a plane orthogonal to a longitudinal axis of the book spine. In other words, the drawing plane of FIGS. 1 and 2 corresponds to a longitudinal section through the photo book 10.

The photo book comprises a display 12, which is arranged in a display page 14, a control electronics 16, which is arranged in a module compartment 18, as well as a connection 20, by means of which the display 12 is connected to the control electronics 16. The connection 20 runs through a cutout 22 in a book spine 24 of the photo book 10, when the photo book 10 is closed.

In the illustrated exemplary embodiment, the photo book comprises a total of six pages, wherein one page is formed as display page 14. The display 12 itself can in particular be an LCD or OLED display and can, for example, also be formed as a touch display. The display 12 serves the purpose of displaying a media content, such as, in particular, a video. In particular, a color display can be used. The photo book 10 according to the invention is to be understood as successor of a conventional photo book because, in addition to images and text, it can also store and play videos and, where applicable, audio information. In particular, it is possible to produce a photo book 10 according to the invention by modification and integration of additional components based on a conventional premium photo book.

The display 12 is controlled by means of the control electronics 16. The control electronics 16 can thereby in particular comprise a corresponding microchip on a printed circuit board. In the illustrated exemplary embodiment, the control electronics 16 is arranged within a module compartment 18 in a cutout 26 in a back book cover 28 of the photo book. The cutout 26 quasi forms the module compartment 18 in this respect. The cutout 26 can be produced, for example, by milling out a cardboard layer in the back book cover 28.

A communication is established between control electronics 16 and display 12 via the connection 20. It is possible in particular that the control electronics 16 controls the display 12 via the connection 20 and that the display 12 is supplied with power via the connection 20. The connection 20 can thereby in particular be formed as a cable, ribbon cable, or flexible printed circuit board (flex printed circuit board). In the illustrated exemplary embodiment, the connection 20 runs through a cutout 15 in the display page 14.

When opening and closing the photo book 10, a kinking of the connection 20 is to be avoided. In order to attain this, a course of the connection 20 is provided through the cutout 22 in the book spine 24. In the illustrated exemplary embodiment, the photo book 10 is bound in a so-called layflat binding. In the closed state of the photo book 10, the connection 20 runs through the cutout 22 in the book spine 24. In the open state, the connection 20 can also run directly from the cutout 15 in the display page 14 through the region of the binding into the module compartment 18 and can quasi be pulled out of the cutout 22 in the book spine.

The cutout 22 is thereby in particular already introduced into the book spine 24 during the production process. In particular, the cutout 22 in the book spine 24 corresponds to a depression, which is introduced subsequently into a material. For example, a region of a cardboard material of the book cover can be milled out. A higher bending radius is made possible for the connection due to the cutout 22, and a stress of the connection 20 is thus reduced. Between cutout 22 in the book spine 24 and display 12 or control electronics 16, respectively, the connection 20 can be guided through slits or cutouts in the regions of the pages of the photo book 10 facing the book spine 24. In the illustrated exemplary embodiment, the cutout 15 in the display page 14 and the cutout 26 in the back book cover 28 each extend all the way to the binding of the pages of the photo book 10. So as not to impact the stability of the photo book 10, the cutout 22 can thereby extend only through a portion of the book spine 24. The cutout can be produced, for example, by cutting out a portion of a cardboard layer, before book cover and inner book are connected in marriage.

An embodiment of a photo book 10 according to the invention with a total of four displays 12 is illustrated in FIG. 3. Two of the four displays 12 are integrated into a common display page 14. The two further displays 12 are integrated into two further display pages 14. It goes without saying that the displays 12 can be arranged on the front and/or rear sides of the display pages 14. In the illustrated exemplary embodiment, the displays 12 are each connected via separate connections 20 to the control electronics 16 in the module compartment 18 in the back book cover 28 of the photo book 10. All connections 20 run through the cutout 22 in the book spine 24. It goes without saying that it is also possible to provide several cutouts 22 in the book spine 24, in order to thus reduce a friction between several connections against one another. Due to the use of a common cutout for the different connections 20, however, a more efficient production is made possible. It is advantageous for an efficient production process when the cutout 22 extends over a majority of the book spine 24 (essentially over the entire width of the photo book or of the book spine, respectively, between front cover and back cover), independently of the number and positioning of the displays 12. In other words, the cutout 22 thus has the same width perpendicular to the longitudinal axis of the book spine, independently of the number and position of the displays 12 in the photo book 10. The length of the cutout 22 along the longitudinal axis of the book spine (in FIG. 3 into the drawing plane) should, in contrast, only be minimally larger than the space taken up by the connection, in order to only impact the stability of the photo book 10 as little as possible. The depth of the cutout 22 is thereby preferably selected in such a way that a sufficiently large bending radius of the connection 20 is attained and the stability of the photo book 10 is nonetheless impacted only insignificantly.

A view of an embodiment of the photo book 10 in the region of the back book cover 28 is illustrated schematically in FIG. 4. In the illustrated exemplary embodiment, the module compartment 18 for the control electronics 16 is formed by a cutout 22 in the back book cover 28 as well as by a cutout 30 in a module page 32, which is connected to the back book cover 28. The module gluing.

In the illustrated exemplary embodiment, the module page 32 is thereby constructed of three layers, wherein the cutout 30 in the module page 32 is provided only in the two lower layers of these three layers facing the back book cover 28. An upper layer of the module page 32 covers the module compartment 18. By connecting the cutout 26 in the back book cover 28 and the cutout 30 in the module page 32, the module compartment 18 is enlarged. It is possible to receive a comparatively large control electronics 16 or to provide thinner pages and a thinner book cover of the photo book, respectively. From the perspective of a viewer of the photo book, the module compartment of the photo book from the outside looks like several regular book pages, which are glued together. The pages are thereby processed so that they only represent a frame after being filled in. The cutout 30 in the module page 32 is surrounded by a frame of the module page in this respect. It goes without saying that several module pages 32, which each have corresponding cutouts, can also be stacked one on top of the other. The frames stacked in this way then form the module compartment. The optics of a conventional photo book is maintained from the outside with the use of the cutouts.

An enlarged view of a display page 14 of the photo book 10 is illustrated schematically in FIG. 5. In the illustrated embodiment, the display page 14 is constructed in several layers, in particular of three layers. The display 12 is arranged in a cutout 34 in a middle layer 36 as well as in a cutout 38 in an upper layer 40. In the illustrated exemplary embodiment, the connection 20 runs through the cutout 15 in the middle layer 36 of the display page 14. The upper layer 40 covers the connection 20 and quasi covers the cutout 15. The front side of the display 12, on which the media content is played back, is thereby visible from the top, i. e. on the side of the upper layer 40. A lower layer 42 of the display page 14, in contrast, does not have a cutout. A rear side of the display 12 is thus not visible for a viewer of the photo book 10. The upper layer 40 and the lower layer 42 can in particular be photo paper layers. The middle layer 36 can be a cardboard layer. In order to produce the cutouts, a laser cutting method can be used in particular. In other words, the cutouts in the display page 14 are only provided in two of three layers. The layer made of photo paper behind the display remains intact, so that the entire page on the rear side of the display can be used as a photo page.

It goes without saying that the cutout 15 and the cutout 34 can also assume only a portion of the middle layer 36 in the depth. An embodiment of a display page 14 of the photo book 10 is illustrated in FIG. 6, in which the cutout 15 at least partially has a wedge-shaped profile in the shown sectional view orthogonal to the longitudinal axis of the book spine 28. As in FIG. 5, the display page 14 has three layers. A height of the cutout 15 in the middle layer 36 decreases with growing distance from the book spine 24. In particular, on its side facing the book spine 24 (on the left in the illustration), the cutout 15 has a larger height than on its side facing the display 12. In the region of the connection 20, the middle layer 36 is quasi still partially present. Due to the larger height on the side facing the book spine 24, a large bending radius of the connection 20 is ensured when opening and closing the photo book. Due to the smaller height on the side of the display 12, an empty space in the display page 14 is avoided, which could lead to an inferior haptics for the viewer of the photo book 10 and/or to a decreased stability of the photo book 10. It goes without saying that the illustrated view represents an exemplary profile.

A display page 14 of the photo book 10, which is formed according to FIG. 5 or 6, is illustrated schematically in FIG. 7 in a perspective view. The position of the upper layer 40 is thereby only suggested by a dashed illustration. The display 12 sits in particular in a cutout 34 in the middle layer 36 (and in a non-illustrated cutout in the upper layer). The lower layer 42 is continuous. In the illustrated exemplary embodiment, the connection 20 runs through the cutout in the middle layer 36 of the display page 14. The upper layer 40 covers the connection 20 and quasi covers the cutout 15. In the illustrated exemplary embodiment, the connection 20 likewise runs in the cutout 34 in the middle layer 36. The cutout 34 is thus continued in the direction of the book spine, in order to receive the connection. Due to the fact that a cutout 15 is also provided for the guidance of the connection 20, said cutout can be inserted in a flexible manner and an efficient production can be made possible in this respect. In addition, the mechanical stress on the connection 20 is further reduced.

The cutout 15 can have, for example, a depth in the z direction of approximately 5 mm. When a ribbon cable or a flexible printed circuit board is used as connection 20, this connection 20 can have a thickness of approximately 0.1 mm to 0.12 mm per display. When several displays are then connected by means of several ribbon cables, which are located one on top of the other, the thickness of the ribbon cables sums up. The summed thickness of the ribbon cables is nonetheless significantly smaller than the depth of the cutout 15 even when using several displays, for example four or five displays. This has the effect that the ribbon cables can become wavy within the cutout 15, in order to thus provide a further flexibility for a length change when opening and closing the photo book.

A further embodiment of the display page 14 of the photo book 10 is illustrated in FIG. 8. It can in particular be seen that the display page 14 comprises further layers. In particular, in the illustrated exemplary embodiment, the display page 14 is constructed of two pages S1, S2 of the photo book 10. These two pages S1, S2 have been connected in a production process of the photo book 10, wherein in particular a gluing can be used to connect the two pages S1, S2. Each of the two pages S1, S2 is constructed of three layers each. The cutout in the display page 14, in which the display 12 is arranged, quasi consists of cutouts in all layers except for the lower layer 42. The cutout, in which the connection is arranged, comprises cutouts in all layers, except in the upper and lower layer. By connecting two pages S1, S2, a conventional photo book can be used and a display 12 can be integrated into this conventional photo book. A sufficient thickness for receiving a display 12 can be attained.

A further embodiment of a display page 14 of a photo book 10 is illustrated in FIG. 9. The display page 14 is formed in three layers with an upper layer 40, a middle layer 36, as well as a lower layer 42. The cutout 15 in the display page 14, in which the connection 20 is arranged, extends through the middle layer 36. The display 12 is arranged in a cutout 34 in the middle layer. The upper layer 40 has a cutout 38, which is smaller than the cutout 34. In other words, a type of undercut is created, by means of which a frame or an edge of the display 12 is covered. The display is quasi incorporated in an edge-free manner into the display page 14. With regard to the illustration in FIG. 9, it is to be noted explicitly that the illustration of the thickness of the layers is not true to scale. In particular, the upper layer 40 can be formed as a photo paper layer and/or can be significantly thinner compared to the middle layer 36.

In the production process, the upper layer 14 is preferably glued, after the display 12 has been introduced. It is advantageous in particular when an embodiment is used, in the case of which two pages of the photo book are connected to form a display page 14. It is then possible that the undercut is introduced in a simple way by means of a corresponding cutting process, before the two pages are connected. In other words, a further frame is cut out around the cut-through cutout for the display, but which further frame is only provided in a portion of the layers. Due to the undercut, an outer (black) edge of the display 12 is covered. It goes without saying that this approach of the undercut can also be used accordingly in the case of several layers. In addition, it goes without saying that the approach of the undercut can also be used independently of the guidance of the connection through the cutout in the book spine.

A photo book 10 in the open state is illustrated schematically in FIG. 10. The photo book 10 comprises an opening sensor 46 for detecting an opening or closing of the display page 14. For example, an automatic playing of videos when the display page 14 is opened can be made possible by means of the opening sensor 46. A viewer of the photo book 10 does not need instructions for playing back a media content. It is sufficient to open the corresponding page of the photo book 10. The opening sensor 46 can thereby in particular be configured as a magnetic field sensor or Hall sensor, respectively. A magnetic field changes when changing a relative position between opening sensor 46 and a counter magnet 47 in the page located opposite the display. It is also possible that a magnetic field change due to a change of the relative position with respect to the control electronics 16 or a separate metal piece or a counter magnet is detected at a different point, for example in the book spine 24. The opening sensor 46 can also be integrated into the connection 20. A power and signal transmission is combined with a sensor in this respect.

FIG. 11 shows a schematic perspective view of the control electronics 16 within the module compartment 18 in the back book cover 28 of the photo book 10. In the illustrated exemplary embodiment, the connection 20 comprises a flexible printed circuit board 48 with at least one conductor track 50. Signals are conducted between control electronics 16 and display via the conductor track 50 or the conductor tracks, respectively. In addition, a power supply can also be established via corresponding conductor tracks. In the illustrated exemplary embodiment, the connection 20 comprises an offset region 52 with an offset in a direction parallel to the book spine (Y direction). This offset makes it possible that a connection point of the connection 20 on the display 12 is arranged in a different height with regard to the book spine or with regard to the Y direction, respectively, than a connection point of the connection 20 on the control electronics 16. In the illustrated exemplary embodiment, the offset region 52 lies within the module compartment 18 in the back book cover 28. However, the offset region 52 preferably lies in the display page 14 (not illustrated). The use of the offset region 52 in the display page 14 has the advantage that only a single narrow cutout in the book spine is required. Connections of several displays can be guided through the same cutout in the book spine, so that said cutout can be dimensioned minimally in its length along the longitudinal axis of the book spine. In addition, space can be saved in the module compartment, a simple manufacturing can be attained, and the stability can be ensured. This offset region 52 can be realized in a simple way with the use of a flexible printed circuit board 48 in the connection 20. In particular, a large flexibility with regard to the arrangement of the display in the control electronics is attained.

It has been shown that thinner cables are usually better suitable for the use than thicker cables. The bending radius of the connection is thereby significant for the service life of the book. A standardized ribbon cable can generally also be used for the connection 20. However, a simple integration of an opening sensor into the connection can be attained with the use of a flexible printed circuit board (flex PCB). In addition, this makes it possible to provide an offset as illustrated in FIG. 11.

A view of the photo book 10 in the region of the back book cover 28 and of the control electronics 16 arranged therein and of the module compartment 18 is illustrated schematically in FIG. 12. Reference is made to the statements with regard to FIG. 4 in this respect. In the embodiment in FIG. 12, a folding region 54 is additionally provided, through which the connection 20 runs. In the illustrated profile, i. e. in a plane orthogonal to the book spine 24, the connection runs in a meander-shaped manner. In the illustrated exemplary embodiment, the folding region 54 is thereby arranged in the module compartment 18.

When opening and closing the photo book 10, the length of the connection 20 or the length of the distance between display and control electronics changes, respectively. In order to display or to compensate this, respectively, it is advantageous when the connection 20 has a variable length. For this purpose, quasi a length-flexible cable section is created by means of the folding region 54. The connection and in particular a flexible printed circuit board or a ribbon cable is placed in the manner of a loop (meander-shaped profile as illustrated). The lower side of the connection in the illustration thereby runs in the direction of the control electronics 16. The upper side runs in the direction of the book spine 24.

It is in particular advantageous thereby that several connections can be placed one on top of the other in the case of a use of several displays in the photo book, in particular in the case of a use of flexible printed circuit boards or ribbon cables as connections. These several connections then have to change their lengths in a certain order when opening and closing the different pages of the photo book. The positioning of the entries and exits of the connections into the folding region is important because an order is specified thereby, in which several connections can “shorten”. When leafing through the photo book page by page, the cable of the display, which is installed farthest to the front in the book, shortens first, and subsequently the connections of displays, which are arranged farther to the back in the photo book. Due to the deflection of the connection, the connection of the first display enters the module compartment 18 or the folding region 54, respectively, at the lowermost point in the illustrated sectional view. So that this connection can shorten first, it has to lie on the inside in the right-hand loop, on the page facing the book spine. This is only possible when the several connections enter the folding region on the top. It follows from this that the cables have to exit on the other side on the bottom, in order to utilize the installation space as optimally as possible. Due to the meander-shaped profile, several connections within the folding region can thus compensate a change in distance between control electronics and respective display independently of one another.

In addition, it is possible and advantageous that the connection 20 on the side of the control electronics 16 is likewise variable with regard to the distance, which is to be spanned. Identically long connection parts or cables of standardized lengths, respectively, can be used thereby, even if they are connected to the control electronics 16 at offset points. Costs can be saved thereby.

In addition, it would be conceivable to provide a guidance of the connection around the control electronics 16 in order to attain a reversal of the connection or of the corresponding ribbon cable, respectively, or of the flexible printed circuit board by 180°. This provides for a use of standard connections. Due to the use of the meander-shaped profile in the folding region 54, a stress on the connection 20 can be reduced significantly. A service life of the photo book 10 is extended.

A protective frame 56, in which the connection 20 is received, is provided in the illustrated example. The protective frame 56 or an inner region of the protective frame 56, respectively, forms the folding region 54.

In FIG. 13, a perspective view of the photo book 10 in the region of the back book cover 28 with the module compartment 18 located therein is illustrated schematically. In addition to the control electronics 16, further components can be arranged in the module compartment 18. In particular, a loudspeaker 58, by means of which an audio signal can be output, can be provided within the module compartment 18 (or also at a different point). In particular, an audio track belonging to a video can be output when the video is played.

An energy storage 60 can furthermore be connected to the control electronics 16 by means of a corresponding conductor track. The energy storage 60 can preferably comprise a lithium ion storage for storing energy. In addition, the energy storage 60 can be configured to inductively receive energy from a corresponding charging device. This makes it possible that the photo book does not have to comprise a charging socket for charging.

In addition, a module frame 62, which protects the components within the module compartment 18 against environmental influences, can be arranged in the module compartment. In particular, a frame made of paper or cardboard can be used, in order to minimize the mechanical stress on the components within the module compartment 18.

In addition, a first switching unit 64 is provided in the module compartment 18 in the exemplary embodiment in FIG. 13. The control electronics 16 and the display can be switched on and off by means of this first switching unit 64. It is likewise possible that functions of the control electronics 16 are controlled. In particular, a button, which is arranged on the edge of the book cover, can be used as first switching unit 64. It is likewise possible to use a touch sensor.

Advantageous arrangements of the loudspeaker 58 within the module compartment 18 are illustrated schematically in FIGS. 14 and 15. In particular, the loudspeaker 58 can adjoin a rebate region 59 of the photo book 10 (FIG. 15) or can protrude into it (FIG. 14). The loudspeaker emits sound in the direction of the rebate region 59. In the case of a loudspeaker 58 protruding into the rebate region 59, the sound can thereby be emitted parallel to the z axis as well as along the x axis in the direction of the rebate region 59 and can reach into the rebate region. A loudspeaker, which protrudes into the rebate region 59 and emits the sound along the y axis, would also be conceivable. A loudspeaker 58, the structural form of which provides for a sound emission in the direction of the x axis into the rebate region 59, can adjoin the rebate region or can even be mounted so as to be set back within the module compartment 18, whereby a reduction of the rebate region is made possible and in particular the optics can be further improved in this way.

A receiving device 65 according to the invention for receiving a photo book 10 is illustrated schematically in FIG. 16. The receiving device 65 corresponds in particular to a stand, into which the photo book 10 can be placed.

In the illustrated exemplary embodiment, the receiving device 65 comprises a charging device 66 for inductively charging an energy storage 60 of the photo book.

In the illustrated exemplary embodiment, the charging device 66 furthermore comprises an integrated energy storage 68. If a separate energy storage is provided within the receiving device 65, the design can be further optimized because a cable connection of the receiving device 65 is necessary only occasionally, in order to charge the integrated energy storage 68 of the receiving device again. During normal operation, the energy storage 60 of the photo book 10 can be charged several times by means of the charging device 66 and the integrated energy storage 68.

A second switching unit 69 of the photo book, which is configured to switch on the control electronics and the display of the photo book 10 when the photo book 10 is removed from the receiving device 65, is furthermore illustrated in the illustrated exemplary embodiment. In particular, a magnetic sensor can be used as second switching unit 69, or a detection of an interruption of the charging current between charging device 66 and energy storage 60 of the photo book 10 can also take place. If it is detected by means of this sensor system that the photo book 10 is removed from the charging device, the photo book 10 can be activated. A manual switch-on is thus not necessary.

Lastly, a locking mount 70 is illustrated in FIG. 16, by means of which the photo book 10 can be locked in the receiving device. In the illustrated exemplary embodiment, the locking mount 70 thereby cooperates with a corresponding locking unit 72 of the photo book 10. For example, two magnets or a magnet and a metal part can be used as locking mount 70 and locking unit 72. A locking is thereby in particular understood as a fixing of a predefined position. For example, a correct positioning of an inductive charging unit of the receiving device 65 with respect to the photo book 10 and the energy storage 60 of the photo book can take place by means of the locking. The handling is improved.

The invention has been described and explained comprehensively on the basis of the drawings and the description. The description and explanation are to be understood as an example and not to be limiting. The invention is not limited to the disclosed embodiments. Other embodiments or variations follow for the person of skill in the art when using the present invention as well as during a detailed analysis of the drawings, of the disclosure, and of the following patent claims.

The words “comprising” and “with” in the patent claims do not rule out the presence of further elements or steps. The indefinite article “a” does not rule out the presence of a plurality. An individual element or an individual unit can carry out the functions of several of the units mentioned in the patent claims. An element, a unit, a device, and a system can be partially or completely implemented in hardware and/or in software. The pure naming of some measures in several different dependent patent claims is to not be understood to the effect that a combination of these measures cannot likewise be used in an advantageous manner. Reference numerals in the patent claims are not to be understood to be limiting.

### REFERENCE NUMERALS

10 photo book
12 display
14 display page
15 cutout in the display page
16 control electronics
18 module compartment
20 connection
22 cutout in the book spine
24 book spine
26 cutout in the back book cover
28 back book cover
30 cutout in the module page
32 module page
34 cutout in the middle layer
36 middle layer
38 cutout in the upper layer
40 upper layer
42 lower layer
46 opening sensor
47 counter magnet
48 flexible printed circuit board
50 conductor track
52 offset region
54 folding region
56 protective frame
58 loudspeaker
59 rebate region
60 energy storage of the photo book
62 module frame
64 first switching unit
65 receiving device
66 charging device
68 energy storage of the receiving device
69 second switching unit
70 locking mount
72 locking unit

1-15. (canceled)

16. A photo book, with:
a display for displaying a predefinable media content, wherein the display is arranged in a display page of the photo book;
a control electronics for controlling the display, wherein the control electronics is arranged in a module compartment of the photo book; and
a connection for electrically connecting the display to the control electronics, wherein, in a closed state of the photo book, the connection runs through a cutout in a book spine of the photo book.

17. The photo book according to claim 16, wherein
the connection between the cutout in the book spine and the display runs in a cutout in the display page.

18. The photo book according to claim 16, wherein the module compartment is arranged in a cutout in a book cover of the photo book.

19. The photo book according to claim 16, wherein
the display page is constructed of at least three layers;
the display is arranged in a cutout in a middle layer of the at least three layers and in a cutout in an upper layer of the at least three layers, which is assigned to a front side of the display;
a lower layer of the at least three layers, which is assigned to a rear side of the display, does not have a cutout in the region of the display.

20. The photo book according to claim 19, wherein
the cutout in the upper layer is smaller than the cutout in the middle layer, so that the upper layer covers an edge of the display; and/or
the upper layer and the lower layer comprise photo paper.

21. The photo book according to claim 16, wherein
the display page is constructed of two pages of the photo book, which are connected in a production process.

22. The photo book according to claim 16, with an opening sensor for detecting an opening of the display page.

23. The photo book according to claim 22, wherein the display is configured for displaying the media content, when the opening of the display page is detected by the opening sensor.

24. The photo book according to claim 16, wherein
the connection comprises a flexible printed circuit board with at least one conductor track.

25. The photo book according to claim 16, wherein a pinout of the control electronics and/or of the display has a symmetrical pinout for connecting the connection.

26. The photo book according to claim 16, wherein
the connection has a meander-shaped profile in a folding region in a plane orthogonal to the book spine, so that the connection in this folding region is configured for compensating a change of a distance between the display and the control electronics when opening and closing the photo book and/or when leafing through the photo book by means of a change of a folding position.

27. The photo book according to claim 16, with:
at least one further display, which is arranged in the display page or in a further display page of the photo book, wherein the control electronics is formed for controlling the at least one further display.

28. The photo book according to claim 16, with a loudspeaker for outputting an audio signal, wherein
the control electronics is configured for controlling the loudspeaker;
the loudspeaker is configured for outputting the audio signal in a rebate region of the photo book; and/or
the loudspeaker is arranged within the module compartment.

29. The photo book according to claim 16, with:
an energy storage, which is configured for inductively receiving energy from a receiving device and/or which comprises a lithium ion storage;
a module frame for receiving the control electronics and the further components in the module compartment, wherein the module frame is configured for introduction into the module compartment;
a first switching unit for switching the control electronics and the display on and off and/or for controlling functions of the control electronics;
a second switching unit for switching on the control electronics and the displays, when the photo book is removed from a receiving device; and/or
a locking unit for locking the photo book in a locked position in a receiving device.

30. A receiving device for mounting a photo book with a photo book according to claim 16, with:
a charging device for inductively charging an energy storage of the photo book; and/or
a locking mount for locking the photo book in a locked position in the receiving device.

31. The photo book according to claim 17, wherein
in a sectional view orthogonally to the book spine, the cutout in the display page has a wedge-shaped profile with a larger height on a page facing the book spine.

32. The photo book according to claim 18, wherein the module compartment is covered by a layer of a page of the photo book.

33. The photo book according to claim 16, wherein
the connection between the cutout in the book spine and the display runs in a cutout in the middle layer.

34. The photo book according to claim 21, wherein
the two pages of the photo book are constructed of three layers each.

35. The photo book according to claim 24, wherein
the flexible printed circuit board has an offset region with an offset in a direction parallel to the book spine, so that a connection point of the connection on the display is arranged at a different point along a longitudinal axis parallel to the book spine than a connection point of the connection on the control electronics.

36. The photo book according to claim 27,
wherein the at least one further connection runs through the same cutout in the book spine of the photo book.
